(19) United States
(12) Patent Application Publication
(10) Pub. No.: US 2009/0184148 A1
(43) Pub. Date: Jul. 23, 2009

(54) Combustion-operated setting tool

(75) Inventors: Tilo Dittrich, Grabs (CH); Mario Grazioli, Chur (CH); Norbert Heeb, Buchs (CH)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/319,681

(22) Filed: Jan. 9, 2009

(30) Foreign Application Priority Data
Jan. 23, 2008 (DE) 10 2008 000 137.6

(51) Int. Cl. B25C 1/08

(52) U.S. Cl. 227/9

(57) ABSTRACT

A combustion-operated setting tool for driving fastening elements, includes a container receptacle (16) for receiving a fuel container (20) and a further receptacle (17) for a network-independent power source (30, a first output element (21) for showing fuel level of the fuel container (20) and at least one further output element (31) for showing a charge state of the network-independent power source (30) and a manually-operated switch (40) for actuating both the first output element (31) and at least one further output element (31).

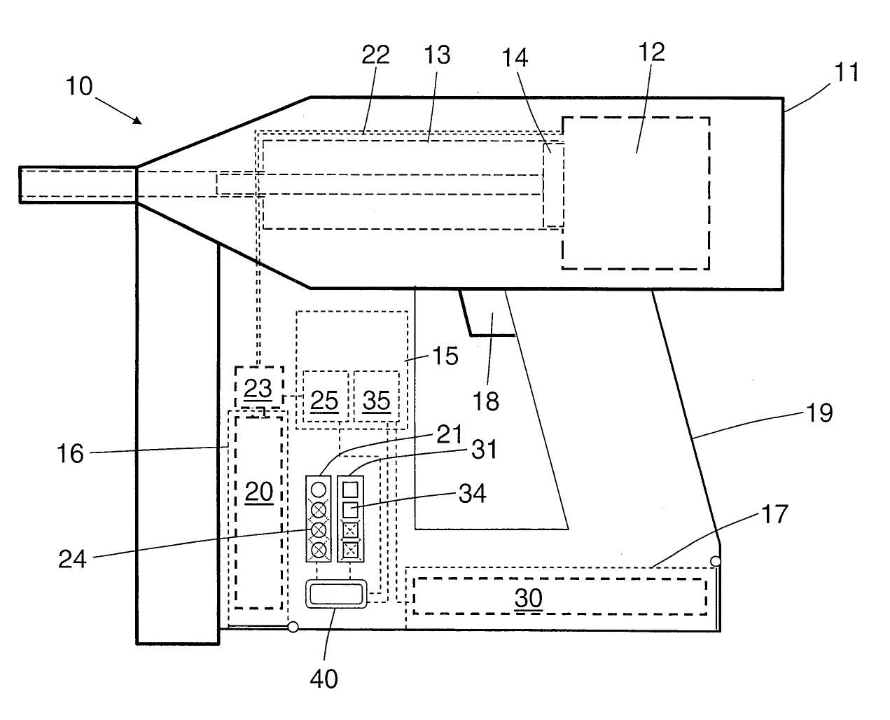

### BACKGROUND OF THE INVENTION

1. Field of the Invention

The present invention relates to a combustion-operated setting tool for driving fastening elements and including a container receptacle for receiving a fuel container, a first output element for showing fuel level of the fuel container, a receptacle for a network-independent power source, and at least one further output element for showing a charge state of the network-independent power source.

2. Description of the Prior Art

Setting tools of the type discussed above are driven by liquid or gaseous fuels stored in propellant or fuel containers replaceably secured on a setting tool. German Publication DE 103 19 646 B3 disclose a combustion-operated setting tool including a fuel-driven setting mechanism and a receptacle for receiving a fuel container. The setting tool is provided with a display for displaying fuel level data of a fuel container located in the receptacle.

U.S. Pat. No. 6,123,241 discloses a combustion-operated setting tool including a fuel-operated setting mechanism and a device for monitoring the pressure in the fuel container. The setting tool also includes a voltage sensor for monitoring a battery voltage. When the pressure in the fuel container falls below a predetermined threshold, a display, which is provided on the setting tool, is actuated, notifying the user about a low pressure state of the fuel in the fuel container. When the voltage sensor detects a low battery voltage, the display is again actuated, notifying the user about a low charge state of the battery.

The drawback of the setting tool of both DE 103 19 646 B3 and U.S. Pat. No. 6,123,246 consists in that an active inquiry by the user of a charge state of the battery or a fuel condition in the fuel container is not possible.

Accordingly, an object of the present invention is to provide a setting tool of the type described above in which the drawback discussed above is eliminated, and the setting tool is user-friendly.

### SUMMARY OF THE INVENTION

This and other objects of the present invention, which will become apparent, hereinafter, are achieved by providing a manually-operated switch for actuating both the first output element and at least one further output element.

The manually-operated switch substantially simplifies control of the output elements and is user-friendly. The user can, by a single actuation of the switch, cause a display a number of state data. In addition to the charge state of the power sourced and fuel level in the fuel container, e.g., the disturbance data (defects of the electronics, of the metering device, of the motor, of a switch (trigger switch, press-on switch) or disturbance in the transportation of fastening elements can be displayed. Further, such data as failure of the fuel container, the number of executed settings, or propriety data can be displayed.

Advantageously, the first output element and the at least one further output element are formed as optical displays located next to each other. With several optical displays located next to each other, the user can grasp the output data with a single glance.

Advantageously, the optical displays are formed as LED-displays, which are economical, robust, and consume little power. Further, the LED-displays can be obtained in different colors and permit to combine different colors in a single LED/e.g., red and green). Thus, different optical signals can be produced with a single LED.

Preferably, the switch is formed as a push-button switch. Such a switch is robust and is easy to operate. Such a switch further automatically returns to its initial position after actuation and communicates only a short pulse to the electronics for actuating the display.

Advantageously, both output elements are actuated by the switch only for a predetermined time period. Thus, the display of data automatically becomes extinct, whereby a power-saving operation of the output elements is insured.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS:

In the drawings:

Single FIGURE shows a schematic side view of a combustion-operated setting tool according to the present invention.

### DETAILED DESCRIPTION OF THE PREFERRED EMBODIMENT

A hand-held setting tool 10 according to the present invention, which operates on a liquid or gaseous fuel and is shown in the drawing, includes a container receptacle 16 in which a fuel container 20 is received. The setting tool 10 has a housing 11 with a handle 19 formed thereon. On the handle 19, an actuation switch 18, with which a setting process is actuated, is arranged. The setting tool 10 further includes a drive having a combustion chamber 12 for combusting an air-fuel mixture, and a setting piston 14 displaceable in a guide 13. The fuel container 20 is replaceably arranged in the container receptacle and is formed, in the embodiment shown in the drawings, as a fuel can. A metering device 23 and a fuel conduit 22 connect the fuel container 20 with the combustion chamber 12.

The setting tool 10 also has a receptacle 17 in which a network-independent current source 30 is replaceably arranged and forms electrical contracts with elements of the setting tool. The network-independent current source 30 can be formed, e.g., as an accumulator.

For controlling of the electrical functions, e.g., for controlling the metering device 23 and the ignition device (not shown in the drawings), there is provided a control unit 35. The control unit 35 can, e.g., include one or several microcontrollers. The control unit 15, which can be formed of several separate or integrated components, includes, among others, a fuel monitoring device 25 for monitoring the fuel level in the fuel container 20 and a monitoring device 35 for monitoring the charge state of the network-independent current source 30.

From outside, a first output element 21 and a further output element 31 are visible in the housing 11 of the setting tool 10. The first and further output elements 21 and 31 (e.g., arranged next to each other) are formed as optical displays in form of LED-displays. The output elements 21 and 31 display the tool condition data. The first output element 21 shows the fuel level in the gas can, and the second output element 31 shows the charge state of the network-independent current source 30. Both output elements 21 and 31 are actuated by a single switch 40. When the switch 40 is actuated for a first time, then, e.g., the first output element 21 is actuated, with a LED 24 of the first output element 21 displaying the fuel level in the fuel container 20, which is determined by the fuel monitoring device 25. In the embodiment shown in the drawing, after actuation of the switch 40, three LEDs 24 become illuminated (shown with dotted crosses). This corresponds to the fuel level in the fuel container of about 75%. After a predetermined time period (e.g., from 1 to 5 sec), the display becomes extinct to save energy.

The further or second output element 31 is likewise actuated by the switch 40. Upon the switch 40 being actuated for a second time, two LEDs 34 become illuminated (as shown with dashed crosses), showing that the current level of the current source 30 is at about 50%. This display likewise becomes extinct, as the output element 21, after a predetermined time period.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A combustion-operated setting tool for driving fastening elements, comprising a container receptacle (16) for receiving a fuel container (20); first output element (21) for showing fuel level of the fuel container (20); a receptacle (17) for a network-independent power source (30); at least one further output element (31) for showing a charge state of the network-independent power source (30); and a manually-operated switch (40) for actuating both the first output element (31) and at least one further output element (31).

2. A combustion-operated setting tool according to claim 1, wherein the first output element (21) and the at least one further output element (31) are formed as optical displays located next to each other.

3. A combustion-operated setting tool according to claim 2, wherein the optical displays are formed as LED-displays.

4. A combustion-operated setting tool according to claim 1, wherein the switch (40) is formed as a push-button switch.

5. A combustion-operated setting tool according to claim 1, wherein both the first output element (21) and the at least one further output element (31) are actuated for a predetermined time period.
